(19) United States
(12) Patent Application Publication
(10) Pub. No.: US 2015/0019940 A1
(43) Pub. Date: Jan. 15, 2015

(54) SYSTEM AND METHOD FOR THE CREATION OF LANGUAGE-LED, COLLABORATIVE MULTIMEDIA DOCUMENTS

(71) Applicant: TellTerms, LLC, Reno, NV (US)

(72) Inventor: Fernando Leal, Reno, NV (US)

(21) Appl. No.: 13/937,293

(22) Filed: Jul. 9, 2013

(51) Int. Cl. G06F 17/21

(52) U.S. Cl. CPC G06F 17/212
USPC 715/201

(57) ABSTRACT

A system and related method are disclosed for the creation of language-led collaborative multimedia documents. The method includes receiving a first user's identification of at least one term, receiving an instruction from the first user or a second user linking that at least one term to an exhibit, and displaying the term to other users with a representation of the exhibit that, when selected, causes the exhibit to display. The first user can control who is invited to link an exhibit to a given term, and who can see which portions of a completed document, or exhibits attendant thereto.

### TECHNICAL FIELD

Embodiments disclosed herein relate generally to electronic manipulation and interrelation of multimedia files, and in particular to the creation of documents with embedded multimedia.

### BACKGROUND ART

The now-ubiquitous presence of the Internet has created many new ways to create, share, and view information. People can exchange or publish videos, images, and audio recordings at breathtaking speed; examples abound of video clips that have achieved international popularity overnight and received hundreds of millions of views. Perhaps equally significant is the revolution the Internet has created in the use of ordinary text. Hyperlinks and similar techniques have made it possible instantly to find and read references supporting scholarship, or to supplement a narrative with images, videos, and audio recordings. This in turn has enabled people to portray themselves more effectively on the Internet, for instance by presenting enhanced resumes or other biographical pages that present them in a variety of media. However, the systems currently existent for developing such pages fall short of the ideal degree of flexibility and ease of use. Products that do not required advanced skills for the assembly of multimedia documents are typically too rigid to allow for full freedom of expression on the part of the user.

Thus, there remains a need for a system that allows users easily and flexibly to assemble biographical documents with seamlessly embedded multimedia.

### SUMMARY OF THE EMBODIMENTS

A method is disclosed for the creation of language-led, collaborative multimedia documents. The method includes receiving, by an application platform, a first instruction from a first user selecting at least one term, receiving, by the application platform, at least one second instruction selecting an exhibit and linking that exhibit to the at least one term, receiving, by the application platform, a third instruction, from the first user, to display the at least one term, displaying, by the application platform, the at least one term and a representation of the exhibit, receiving, by the application platform, a selection, by a user, of the representation of the exhibit, and displaying, by the application platform, the exhibit.

In a related set of embodiments, receiving the first instruction further comprises maintaining a dictionary of terms and receiving a selection of at least one term in the dictionary from the first user. Some embodiments involve displaying, by the application platform, a set of term category descriptions, receiving, by the application platform, a selection by the first user of a category description, and displaying, by the application platform, terms associated with that category description. In some embodiments, receiving the first instruction comprises receiving at least one term entered by the first user and receiving a selection of the at least one entered term.

Under additional embodiments, receiving the at least one second instruction comprises receiving the at least one second instruction from the first user. In further embodiments, receiving the at least one second instruction comprises receiving an instruction from the first user identifying at least one additional user, sending the at least one term to an electronic device used by the at least one additional user, and receiving the at least one second instruction from the electronic device. In a related embodiment, the at least one term is sent to the electronic device by means of a social network. In another related embodiment, further comprising receiving the exhibit from the electronic device. According to further embodiments, sending the at least one term further comprises placing the at least one term in a document and sending the document to the electronic device. Other related embodiments involve receiving, by the application platform, an instruction from the first user identifying terms to which the at least one additional user may link exhibits, and displaying the representation of the exhibit only if the second instruction directs the application platform to link the exhibit to one of the identified terms. In some additional embodiments, receiving the second instruction further comprises sending, by the application platform, a query to at least one electronic device, receiving, by the application platform, a list of potential exhibits matching the query from the at least one electronic device, displaying, by the application platform, the list of potential exhibits to a user, and receiving, by the application platform, an instruction selecting at least one potential exhibit from the list.

In some additional embodiments, receiving the third instruction comprises receiving, by the application platform, text entered by the first user and identifying, by the application platform, the at least one term in the text. In some embodiments, the application platform receives a plurality of second instructions, and the method also involves ranking, by the application platform, the plurality of exhibits identified by the plurality of second instructions and displaying, by the application platform, representations of the plurality of exhibits in order of ranking. In a related embodiment ranking the exhibits comprises receiving ranking instructions from the first user. According to an additional embodiment displaying the at least one term and the representation of the exhibit further comprises receiving, by the application platform, an instruction from the first user not to display the representation of at least one exhibit and displaying, by the application platform, the representations only of exhibits not identified in the instruction not to display. Under another related embodiment, displaying the at least one term and the representation of the exhibit further comprises printing a document containing the at least one term and a code containing a representation of the exhibit.

Another embodiment involves receiving, by the application platform, an instruction from the first user associating the at least one term with a second term, receiving, by the application platform, an instruction from the first user, directing the application platform to display the second term, displaying, by the application platform, the second term and a representation of each exhibit linked to the first term, receiving, by the application platform, a selection by a user of at least one of the representations, and displaying, by the application platform, the exhibit corresponding to the selected representation. An additional embodiment involves maintaining, by the application platform, a thesaurus of lexicographic relationships between terms, retrieving, by the application platform, from the thesaurus a list of terms related to the at least one selected term, and displaying, by the application platform, the list to the first user. Another method involves maintaining, by the application platform, a set of user-specific display rules, identifying, by the application platform, a user, and displaying, by the application platform, only the content permitted to display to that user by the user-specific display rules.

Also claimed is a system for the creation of language-led, collaborative multimedia documents, including an application platform comprising at least one server connected via a network to at least one client device, a data collection component, executing on the application platform, receiving a first instruction from a first user selecting at least one term, receiving at least one second instruction selecting an exhibit, and directing the application platform to link that exhibit to the at least one selected term, receiving a third instruction, from the first user, directing the application platform to display the at least one selected term, and receiving, by the application platform, a selection by a user of a representation of the exhibit, and a display component, executing on the application platform, displaying the at least one selected term and a representation of the exhibit, and displaying the exhibit.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1 is a flow chart illustrating one embodiment of the claimed method.

FIG. 2 is a schematic diagram depicting an example of an electronic device as described herein.

FIG. 3 is a schematic diagram of a network-based platform, as disclosed herein.

FIG. 4 is a block diagram depicting one embodiment of the disclosed system.

### DETAILED DESCRIPTION OF SPECIFIC EMBODIMENTS

### Definitions

As used in this description and the accompanying claims, the following terms shall have the meanings indicated, unless the context otherwise requires.

An “electronic device” is defined as including personal computers, laptops, tablets, smart phones, and any other electronic device capable of supporting an application as described herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry devices” is a general term for all equipment coupled to an electronic device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “manual data entry devices” is the set of all data entry devices coupled to the electronic device that permit the user to enter data into the electronic device using manual manipulation. Manual entry devices include without limitation keyboards, keypads, touchscreens, track-pads, computer mice, buttons, and other similar components.

An electronic device's “optical data entry devices” are components coupled to the electronic device that record images on an electronic image sensor, for instance using a digital camera, video camera, or scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other electronic devices have existed for decades, and are known to persons of ordinary skill in this invention's technical field. Furthermore, persons of ordinary skill in the art will be aware of cameras that can be attached to computers to transfer video that they have captured, digital video cameras that operate while attached to computers (i.e. “webcams”), and the digital cameras capable of capturing video that are built into many mobile phones.

An electronic device's “digital scanning devices” as used herein is a general term for all equipment coupled to an electronic device that may be used to capture and record in digital form data stored in an object not coupled to the electronic device. Digital scanning devices includes, without limitation, laser scanners or digital cameras for reading bar codes, optical scanners or digital cameras for reading QR codes or printed text, RFID readers, NFC readers, magnetic readers, and any other electrical component capable of capturing a pattern in solid shapes, variations in electromagnetic forces or radiation, variations in heat or pressure, or the output of any method for signal storage or propagation.

An electronic device's “audio data entry devices” are devices that capture sound waves and vibrations and convert them into a digital signal that may be stored and played by an electronic device. Audio data entries include, without limitation, microphones.

An electronic device's “display” is a device coupled to the electronic device, by means of which the electronic device can display images. Display include without limitation monitors, screens, television devices, and projectors.

To “maintain” data in the memory of an electronic device means to store that data in that memory in a form convenient for retrieval as required by the algorithm at issue, and to retrieve, update, or delete the data as needed.

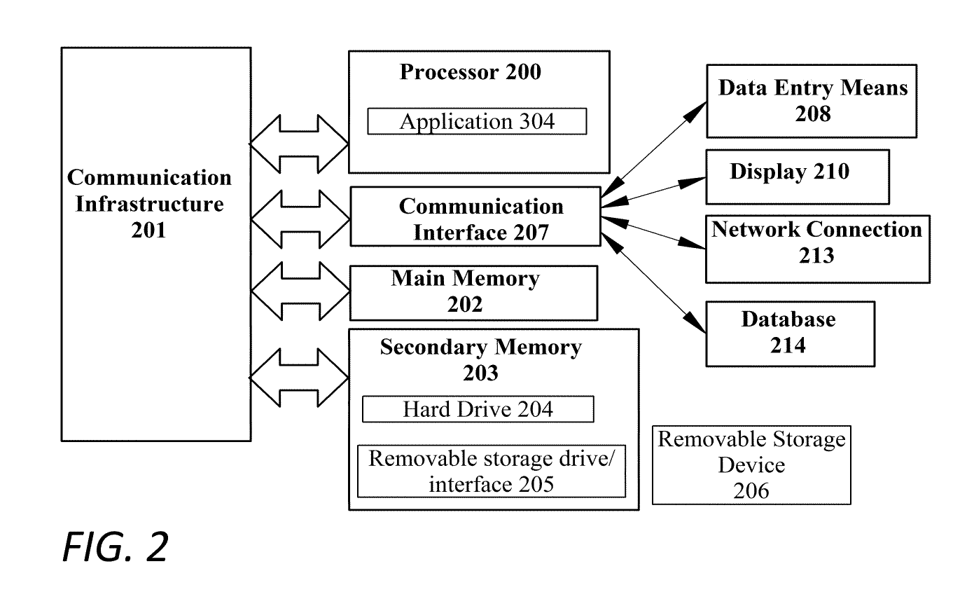

The system and method disclosed herein will be better understood in light of the following observations concerning the electronic devices that support the disclosed application, and concerning the nature of web applications in general. An exemplary electronic device is illustrated by FIG. 2. The processor 200 may be a special purpose or a general-purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

The electronic device may also store data in database 212 accessible to the device. A database 212 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 212, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

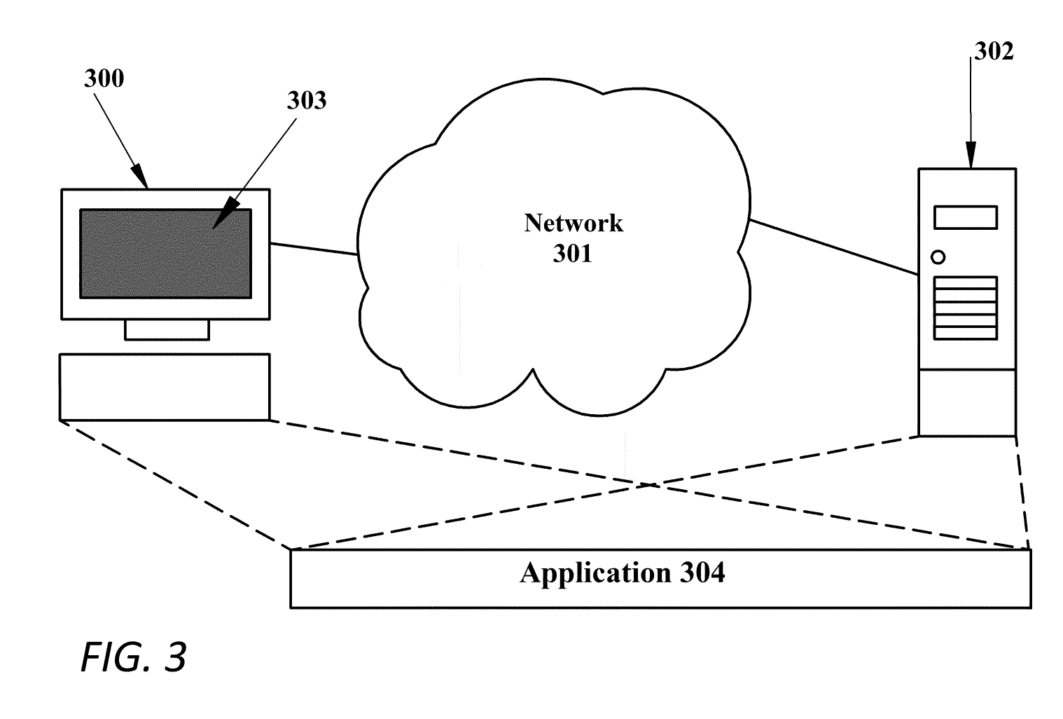

The systems may be deployed in a number of ways, including on a stand-alone electronic device, a set of electronic devices working together in a network, or a web application. Persons of ordinary skill in the art will recognize a web application as a particular kind of computer program system designed to function across a network, such as the Internet. A schematic illustration of a web application platform is provided in FIG. 3. Web application platforms typically include at least one client device 300, which is an electronic device as described above. The client device 300 connects via some form of network connection to a network 301, such as the Internet. The network 301 may be any arrangement that links together electronic devices 300, 302, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 301 is at least one server device 302, which is also an electronic device as described above. Of course, practitioners of ordinary skill in the relevant art will recognize that a web application can, and typically does, run on several server devices 302 and a vast and continuously changing population of client devices 300. Computer programs on both the client device 300 and the server device 302 configure both devices to perform the functions required of the web application 304. Web applications 304 can be designed so that the bulk of their processing tasks are accomplished by the server device 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server device 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications 304 require some computer program configuration of both the client device (or devices) 300 and the server device 302 (or devices). The computer program that comprises the web application component on either electronic device's system FIG. 2 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Some embodiments of the disclosed method and system involve communication with social networks. A social network may be any facility connected to the network 301 that establishes connections from one user to at least another user based upon the relationship between the users. The relationship may be based solely upon an invitation from one user to another to connect. The relationship may be based upon a familial relationship. The relationship may be based upon a romantic relationship. The relationship may be based upon a collegial relationship. Some users of social networks are connected to each other by virtue of attendance at a common educational institution. Some users of social networks are connected to each other by virtue of attendance at a common religious institution. Each user of a social network has a user account that lists that user's connections. The user account may also provide information identifying the user. The user account may include the user's name. The user account may include the user's occupation. The user account may include the user's geographical location. The user account also may contain a mechanism by means of which the user may be contacted. In some cases, the user account only permits contact via the social network, from users connected to the user. In some cases, the user account only permits contact via the social network, but that contact is open to users who are not connected to the user. In some cases, the user account lists direct contact information such as an electronic mail address.

Aspects of the disclosed system and method permit a user to link words or phrases directly with other text, imagery, videos, or recordings illustrating the meaning of the words or phrases in an individualistic manner. The user can also invite others to link exhibits of their own to a word or phrase, creating a flexible but powerful tool for combining references, illustrations, and descriptions together to create a biographical document, such as a resume. Some embodiments enable the user to control where other users can append exhibits, and others enable the user to control which portions of the assembled document are visible to which other users. The user may also direct the system to aggregate files concerning the user from other sites around the internet, for use in the user's own endeavors.

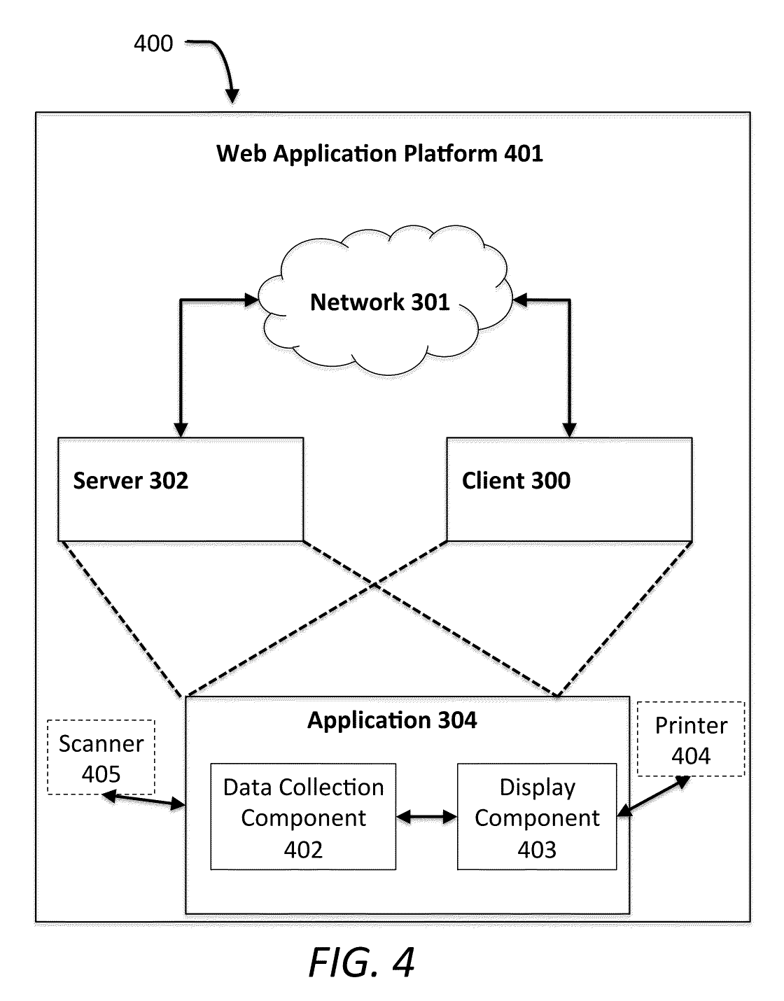

FIG. 4 illustrates some embodiments of the disclosed system 400. The system 400 comprises an application platform 401 comprising at least one server 302 connected via a network 301 to at least one client device 300. In some embodiments the at least one server 302 is a server 302 as disclosed above in reference to FIGS. 2 and 3. In some embodiments, the client device 300 is a client device 300 as disclosed above in reference to FIGS. 2 and 3. The application platform 401 is programmed or configured to perform the tasks of an application 304. The application 304 may be composed of one or more computer programs as described above in reference to FIGS. 2 and 3. The tasks the application 304 performs may be conceptually divided into a data collection component 402 and a display component 403. The organization of tasks into those 2 components solely reflects a categorization of the tasks to be performed, and does not dictate the architecture of particular implementations of the system 400. Some of the programs the application 304 comprises may execute on the client device 300 and some may execute on the server 302.

The system 400 includes a data collection component 402. In some embodiments, the data collection component 402 communicates with the data entry devices of a client device 300. In some embodiments, the communication with the data entry devices of a client device 402 occurs over the network 301 and via the client device 300. In some embodiments, the data collection component 402 communicates with the manual data entry devices of a client device. In some embodiments, the data collection component 402 communicates with optical data entry devices of a client device 300. In some embodiments, the data collection component 402 communicates with digital scanning devices of a client device 300. In some embodiments, the data collection component 402 receives data from client devices 300 that has been previously captured and stored in the memory of the client devices 300. In some embodiments, the data collection component 402 communicates with a scanner 405. The scanner may be a digital scanning device as described above.

The system 400 includes a display component 403 executing on the application platform 401. The display component displays files to users of the system 400 as set forth in more detail below. The display component 403 in some embodiments communicates with the display of the client device 300. In some embodiments, the display component 403 communicates with the displays of multiple client devices 300 (not shown) via the client devices 300. In some embodiments, the display component communicates with a printer 404. The printer 404 may be a document printer such as an inkjet or laser printer. The printer 404 may be a photo printer. The printer 404 may be a device that produces a concrete product using digital information, such as a “three dimensional printer.” In particular, the printer 404 may print out circuitry. The printer 404 may produce radio frequency identification (RFID) tags. The printer 404 may produce RFID tags connected to a document. The printer 404 may produce other digital information that an electronic device can capture using scanning devices.

In some embodiments, the application functions as a primarily server-side “thin client” application, as described above in reference to FIG. 3. For instance, in some embodiments, all of the tasks described below for the data collection component 402 are performed by programs operating on the server 302, and the client device 300 merely relays data entered to the server via a web browser or similar thin client program. Likewise, in some embodiments, the tasks of the display component 403 are all processed on the server 302, and the client device 300 merely displays the output of those programs; for example, a video displayed to the user by the display component 403 may execute on the server 302, and stream to the client device 300 which displays the streamed data as it arrives. In some embodiments, the application functions primarily as a client-side application, as described above in reference to FIG. 3. For example, the data collection component 402 may exclusively process on the client device 300, while using the server 302 solely as a relay to receive data entered via the network 301 from other devices. Likewise, the display component 403 may display exclusively on the client device 300. In some embodiments, the client device 300 and the server device 302 are the same electronic device. In some embodiments, several devices act simultaneously as client devices 300 and as servers 302, exchanging information between them.

The application 304 in some embodiments manipulates terms. “Terms” may be any textual string. Without limitation, a term may be a number. A term may be a letter. A term may be a word. A term in some embodiments is a phrase. In some embodiments, a term is a sentence. Any string of symbols used to convey meaning in any language may be a term. The application 304 also builds and processes documents in some embodiments. A “document” in this context is a persistent command to an electronic device to display a collection of terms stored in data accessible to the electronic device. A document may be a word processing document. A document in some embodiments is a text file. In some embodiments, a document is a file in portable document format (PDF). A document may be a comma-separated file. A document may be a spreadsheet. In some embodiments, documents are self-describing files such as extensible markup language (XML) files. A document may be a hypertext markup language (HTML) file. A document may be any data structure bearing a collection of terms. In some embodiments, a document is a tree of terms. In some embodiments, a document is a list of terms. A document is an array of terms in other embodiments.

The application 304 in some embodiments functions to manipulate exhibits. Exhibits in this context are files that may be linked to terms as set forth below. Exhibits in some embodiments are documents, as described above. In some embodiments, exhibits are image files. In some embodiments, exhibits are audio files. In some embodiments, exhibits are video files. Exhibits may be stored on the application platform 401. Exhibits may be stored in another location, from which the application platform can cause the exhibits to be displayed.

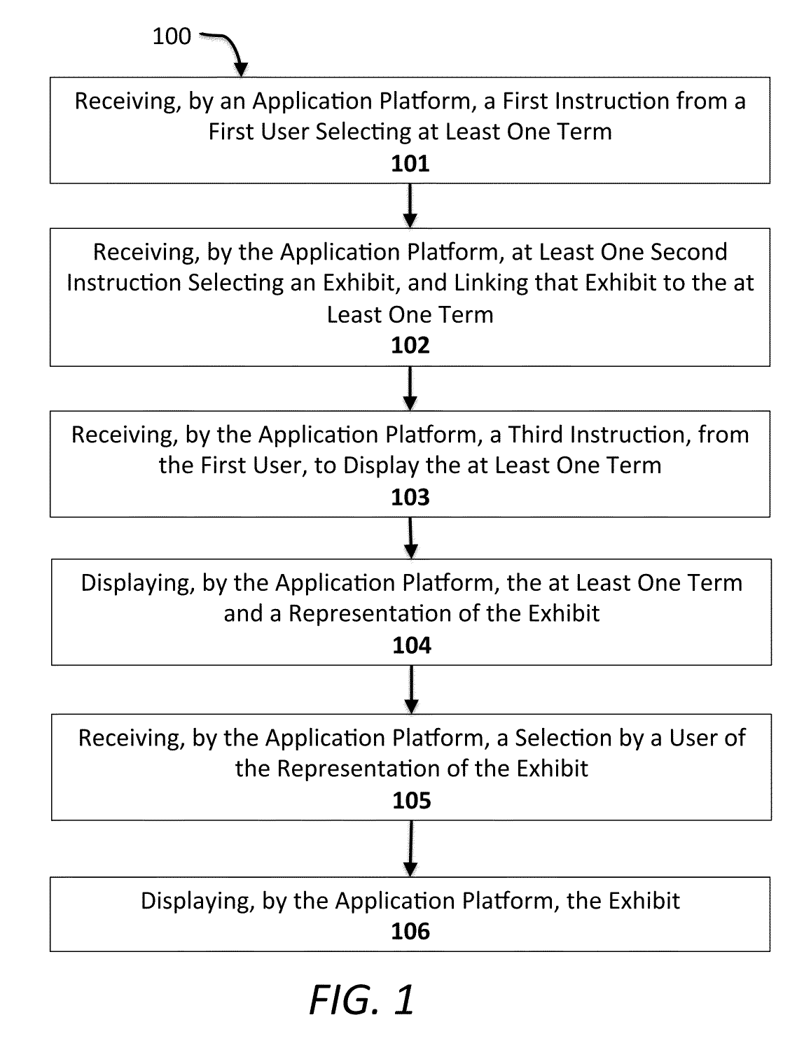

FIG. 1 illustrates some embodiments of the disclosed method 100. The method 100 includes receiving, by an application platform, a first instruction from a first user selecting at least one term (101). In addition, the method 100 includes receiving, by the application platform, at least one second instruction selecting an exhibit, and linking that exhibit to the at least one term (102). The method 100 also includes receiving, by the application platform, a third instruction, from the first user, to display the at least one term (103). The method 100 further includes displaying, by the application platform, the at least one term and a representation of the exhibit (104). The method 100 additionally includes receiving, by the application platform, a selection, by a user, of the representation of the exhibit (105). The method 100 includes displaying, by the application platform, the exhibit (106) as well.

More particularly, and with reference to FIG. 4, the method 100 includes receiving, by an application platform, a first instruction from a first user selecting at least one term (101). In some embodiments, the data collection component 402 receives the first instruction by maintaining a dictionary of terms and receiving a selection of at least one term in the dictionary from the first user. The dictionary of terms may be a database 214 as described above in reference to FIG. 2. The terms in the dictionary are words and phrases useful for describing personal attributes in some embodiments. In some embodiments, the terms in the dictionary are words and phrases useful for describing personal accomplishments. In some embodiments, the terms in the dictionary are words or phrases useful for describing professional accomplishments. The terms in the dictionary in some embodiments are words or phrases that may be used to describe occupational responsibilities. In some embodiments, terms in the dictionary are words or phrases that may be used to describe job descriptions. In some embodiments, terms in the dictionary are words or phrases that may be used to describe various kinds of personal relationships. In some embodiments, terms in the dictionary are words or phrases useful for describing professional relationships. The display component 403 in some embodiments presents the first user with a list of terms from the dictionary. In some embodiments, the data collection component 402 analyzes text entered by the first user and calculates probable related terms from the database using templates stored in data accessible to the application platform 401. The list of probable related terms may be displayed to the first user by the display component 403. In some embodiments, the first user may directly select the displayed terms via manual data entry devices. In some embodiments, the first user may type one of the displayed terms using manual data entry devices accessible to the application platform 401. Some embodiments of the method involve displaying, by the application platform, a set of term category descriptions, receiving, by the application platform, a selection by the first user of a category description, and displaying, by the application platform, terms associated with that category description. In some embodiments, the display component 403 displays to the user a set of term category descriptions. As an example, a list of category descriptions in one embodiment lists category descriptions including “professional skills,” “education,” “previous employers,” “accomplishments,” “personality,” “family,” “hobbies,” and “personal.” When the user selects a particular category in some embodiments, the display component 403 displays terms associated with that category. The associations between a term and a category may be maintained in memory accessible to the application platform 401. The associations may be maintained in a database table. The associations may be maintained in a file. The associations may be maintained as a set of numbers in a matrix.

In some embodiments, the application 304 records the use of terms by the first user and compares the use of those terms by the first user to their use in the dictionary. The application 304 may compare the categories of the terms as used by the first user to the categories in which the terms are placed in the dictionary. In some embodiments, the application 304 may compare the association between terms the user entered with other terms to the associations used in the dictionary. In some embodiments, when the application 304 detects a novel use of a term, it adds that use to the dictionary. In some embodiments, the application 304 maintains a threshold number for novel uses; a novel use for a term is added only after the number of distinct instances of the novel use exceeds the threshold number. In some embodiments, the novel use is added only after the number of distinct users applying that use exceeds the threshold number.

In some embodiments, the data collection component receives the first instruction by receiving at least one term entered by the first user and receiving a selection of the at least one entered term. The first user in some embodiments enters the at least one term using manual data entry devices coupled to the application platform 401. In some embodiments, the first user types the at least one term. In some embodiments, the first user copies and pastes the at least one term from another source. The first user enters the at least one term in some embodiments by uploading a document the first user previously created to the application platform 401. The first user selects the at least one term in some embodiments by highlighting the term. In some embodiments, the display component 403 displays a button that the first user can press using manual data entry means to select a highlighted term. The button may be any graphical object that the first user can select via manual data entry devices available to the application platform 401. In some embodiments, the display component 403 displays a button that causes a subsequently entered term to be selected. In some embodiments, the display component 403 displays a textual entry field in which the user may type a term that the first user wishes to select. In some embodiments, the data collection component 402 searches the terms the first user has entered for matches with terms in the dictionary, and the display component asks the first user whether the first user wishes to select each matching term, and provides the first user with a button the activation of which selects the matching term.

In addition, the method 100 includes receiving, by the application platform, at least one second instruction selecting an exhibit, and linking that exhibit to the at least one term (102). In some embodiments, the data collection component 402 receives the at least one second instruction from the first user. The first user may enter the second instruction by uploading an exhibit. The first user may enter the second instruction by indicating an exhibit already present in the memory of the application platform 401. The first user may enter the second instruction by providing the data collection component 402 with a network address where an exhibit may be found. The first user may enter the second instruction by creating an exhibit using data entry devices accessible to the application platform 401. In some embodiments, the first user enters the data using optical data entry devices. The user may scan a document. The user may scan an image. The user may take a digital photograph. The user may take a video. The user in some embodiments enters the exhibit using audio data entry devices. In some embodiments, the user enters the exhibit using manual data entry devices. The user may enter the exhibit by typing.

In some embodiments, the data collection component 402 receives the at least one second instruction by receiving an instruction from the first user identifying at least one additional user, sending the at least one term to an electronic device used by the at least one additional user, and receiving the at least one second instruction from the electronic device. The first user may identify the at least one additional user using data entry devices available to the application platform 401. The first user may use manual data entry devices to enter information identifying the at least one additional user. The first user may identify the at least one additional user each time the first user selects the at least one term.

In some embodiments, the data collection component 402 maintains a contact list identifying persons with whom the first user has a relationship. In some embodiments, the user creates the contact list by entering the identities of other persons via data entry devices available to the application platform 401. In some embodiments, the user enters the identities using manual data entry devices. In some embodiments, the data collection component 402 imports a contact list from another device. The data collection component 402 may import the contact list from an email account belonging to the first user. The data collection component 402 may import the contact list from a user account belonging to the first user on a social network. The data collection component 402 may import the contact list from a messaging account belonging to the first user. The data collection component 402 may import the contact list from a mobile device used by the first user. In some embodiments, the data collection component 402 creates the contact list by querying other electronic devices connected to the network 301 for relationship data concerning the first user. The relationship data may be any information that identifies a person as having a relationship with the first user. The relationship data may identify institutions with which the user has a relationship. The institutions may be educational institutions at which the user is currently enrolled. The institutions may be educational institutions at which the user was formerly enrolled. The institutions may be current places of employment. The institutions may be past places of employment. The institutions may be social clubs at which the user is currently a member. The institutions may be social clubs at which the user was previously a member. The institutions may be vendors of services whom the first user has given identifying information. The institutions may be vendors of goods whom the user has given identifying information. The institutions may be religious institutions at which the user is currently a member. The institutions may be religious institutions at which the user was formerly a member. In some embodiments, the data collection component 402 adds other persons connected to an institution with which the user enjoys a connection as described above to the contact list.

In some embodiments, the data collection component 402 identifies every member of the contact list as an additional user from whom to receive the at least one second instruction. In some embodiments, the data collection component 402 identifies only a subset of the contact list as an additional user from whom to receive the at least one second instruction. In some embodiments, the data collection component 402 maintains a plurality of contact lists regarding the first user. Each contact list in the plurality of contact lists may identify persons whose relationship with the first user fits a particular category. For instance, one contact list may identify current colleagues of the first user. One contact list may identify former colleagues of the user. A contact list may identify current classmates of the first user. A contact list may identify former classmates of the first user. A contact list may identify members of a religious institution with which the user is a current or former member. In some embodiments, a contact list maintained by the data collection component 402 contains data describing the relationship a person identified in the contact list has to the first user. For instance, the contact list may contain data identifying a person on the contact list as a current or former colleague of the first user. The contact list may contain data identifying a person as the current supervisor of the first user. The contact list may contain data identifying a person as a former supervisor of the first user. The contact list may contain data identifying a person as a relative of the first user. In some embodiments, the data collection component 402 selects persons from one or more contact lists according to their relationship with the first user. In some embodiments, the data collection component 402 selects only current coworkers. In some embodiments, the data collection component 402 selects only former coworkers. The data collection component 402 may select persons who are not current coworkers. The data collection component 402 may select persons who are not former coworkers. In some embodiments, the data collection component 402 selects only former supervisors. In some embodiments, the data collection component 402 selects only current supervisors. In some embodiments, the display component 403 displays the list of persons selected by the data collection component 402 to the user prior to contacting them. The data collection component 402 may accept an instruction from the user eliminating persons from that list. The data collection component 402 may accept an instruction from the user adding persons to that list.

Once the data collection component 402 has selected the at least one additional user, the data collection component 402 sends the at least one term to an electronic device used by the at least one additional user. The data collection component 402 in some embodiments sends the at least one term using the network 301. The data collection component 402 may use any means that permit the transmission of data over a network 301 from one device to another. The data collection component 402 may send the at least one term via electronic mail (email). The electronic mail may be sent using simple mail transfer protocol (SMTP). The data collection component 402 may send the at least one term via a text messaging technology. The data collection component 402 may send the at least one term via voice over Internet protocol (VoIP). The data collection component 402 may send the at least one term using Transfer Control Protocol and Internet Protocol (TCP/IP). The data collection component 402 may send the at least one term via hypertext transfer protocol (HTTP). The data collection component 402 may send the at least one term via file transfer protocol (FTP).

In some embodiments, the at least one term is sent to the electronic device by means of a social network. In some embodiments, the at least one term is sent to the at least one additional user's account in the social network. In some embodiments, the at least one term is forwarded to users connected to the at least one additional user by the social network. In some embodiments, the at least one term is forwarded to the connected users in response to an instruction by the at least one additional user. In some embodiments, the at least one term is forwarded to connected users that fit a particular relationship criterion. For example the at least one term may be forwarded to connected users that are former co-workers of the first user. The at least one term may be forwarded to connected users that are current co-workers of the first user. The at least one term may be forwarded to connected users that are current supervisors of the first user. The at least one term may be forwarded only to connected users that are not current co-workers of the first user. The at least one term may be forwarded only to connected users that are not current supervisors of the first user.

In some embodiments, the data collection component 402 sends the at least one term by placing the at least one term in a document, and sending the document to the electronic device. The document may be a resume. The document may be a biography. The document may be a web page. In some embodiments, the document is an email. In some embodiments, the document contains a plurality of terms that the first user has selected, and with regard to which additional users may enter the second instruction. The selected terms may be highlighted. The selected terms may be presented as hyperlinks. The selected terms may be displayed with buttons that when selected present the additional user with options for associating an exhibit with a term. Options may include entering text. Options may include uploading a file. Options may include entering the network location of a file. Options may include recording a video file using optical data entry devices available to the electronic device. Options may include creating an image file using optical data entry devices available to the electronic device. Options may include recording an audio file using audio data entry devices available to the electronic device.

Some embodiments of the method 100 include receiving the exhibit from the electronic device. The data collection component 402 may receive the exhibit as a set of binary data transmitted over the network from the electronic device. The data collection component 402 in some embodiments receives the exhibit from the electronic device via FTP. In some embodiments, the data collection component 402 receives the exhibit from the electronic device via HTTP. In some embodiments, the data collection component 402 receives the exhibit from the electronic device via TCP/IP. In some embodiments, the data collection component 402 receives the exhibit from the electronic device by means of an email protocol such as SMTP. The exhibit may be sent in the body of an email. The exhibit may be sent as an attachment to an email. The electronic device may place the exhibit with a third-party server from which the data collection component 402 can retrieve the exhibit. In some embodiments, the electronic device sends the data collection component 402 a network address at which the exhibit is located.

In some embodiments, receiving the second instruction from the at least one additional user involves receiving, by the application platform, an instruction from the first user identifying terms to which the at least one additional user may link exhibits, and displaying the representation of the exhibit only if the second instruction directs the application platform to link the exhibit to one of the identified terms. For instance, where the at least one additional user is a former supervisor of the first user, the first user may enter an instruction identifying a set of terms relating solely to the scope of the first user's employment while working for that additional user. The first user may enter the instruction using data entry devices coupled to the application platform 401. The first user may enter the instruction by means of manual data entry devices coupled to the application platform 401. In some embodiments, the data collection component 402 accepts the instruction from the first user immediately before sending the at least one term to the electronic device. In some embodiments, the display component 403 prompts the first user to enter the instruction before the data collection component 402 sends the term to the electronic device. In some embodiments, the data collection component 402 receives the instruction from the first user at an earlier time, and saves it for later use in memory accessible to the application platform 401. The instruction may pertain to a particular term, whenever used by the first user. The instruction may pertain to a particular term, in a particular context within a document. For example, the instruction may allow a former supervisor to comment on a term describing work performance by the first user, when it appears in a part of a document pertaining to work experience. The instruction may pertain to a set of terms. For example, the instruction may permit a former co-worker to comment only on a set of terms that describe the first user's teamwork. The instruction may identify a particular additional user. In some embodiments, the instruction identifies categories of additional users to whom the instruction applies. For example, the instruction may apply to the set of all former co-workers at a particular firm. In some embodiments, the data collection component 402 applies two or more instructions with regard to an additional user to whom the two or more instructions are each applicable. The data collection component 402 may allow comment on the union of allowable terms in the two or more instructions. For example, the data collection component 402 might allow comment from a co-worker who is also a member of the first user's religious institution to comment on both work-related terms and terms describing the first user's religious activities. The data collection component 402 in some embodiments allows comment on the intersection of allowable terms in the two or more instructions. For instance, one instruction may allow former co-workers to comment on terms describing the first user's former job performance and team behavior, and current co-workers to comment on the first user's current job performance and team behavior; the data collection component 402 may allow an additional user who is both a current and a former co-worker only to comment on the first user's team behavior.

In some embodiments, receiving the second instruction involves sending, by the application platform, a query to at least one electronic device, receiving, by the application platform, a list of potential exhibits matching the query from the at least one electronic device, displaying, by the application platform, the list of potential exhibits to a user, and receiving, by the application platform, an instruction selecting at least one potential exhibit from the list. The first user may design the query. For example, the user may instruct the data collection component 402 to find all videos in which the name of the first user appears in the video title, metadata, or description. The data collection component 402 may design the query. As an example, the data collection component 402 may search an uploaded resume of the first user for the names of former workplaces, and search for files bearing the names of those workplaces. The data collection component 402 may search for files located on electronic devices maintained by former workplaces. The data collection component 402 may search for files located on electronic devices maintained by former workplaces that contain information identifying the first user. The data collection component 402 may extract from a document describing the first user's work experience the identity of a team on which the first user worked, and search for files whose contents, description, or metadata refers to that team.

The method 100 also includes receiving, by the application platform, a third instruction, from the first user, to display the at least one term (103). In some embodiments, the display component 403 presents the user with a list of terms, and the user selects a term from the list for display. In some embodiments, receiving the third instruction involves receiving, by the application platform, text entered by the first user, and identifying, by the application platform, the at least one term in the text. The first user may enter the text using data entry devices coupled to the application platform 401. The user may enter the text via manual data entry devices coupled to the application platform 401. In some embodiments, the user writes a document in a text-editing program such as a word processor. In some embodiments, the first user enters the at least one term in a dialog box displayed by the display component 403. As an example, the first user may open a word processor on the application platform 401 and write a resume in the word processor. The application 304 may compare each term that the first user enters to the terms the first user selected. Where a term matches, the application 304 may treat that term as selected for display. The first user may upload a document to the application platform 401, from which the application extracts terms, comparing the terms to those selected by the first user in the previous method steps, and treating matching terms as selected for display. If the user selected the terms, as set forth above in reference to 101, by uploading a document and selecting terms from that document, the application 304 may treat those selected terms as selected for display. If the user selected the terms, as set forth above in reference to 101, by creating a document and selecting terms from that document, the application 304 may treat those selected terms as selected for display.

In some embodiments, the data collection component 402 stores the associations between terms and exhibits in memory accessible to the application platform 401. In some embodiments, each term the first user selected is stored in memory reserved for the first user. Each term in some embodiments is stored in memory with information permitting the application 304 to locate and display each exhibit associated with that term. The information may be the location of each exhibit within memory accessible to the application platform. The information may be the location of each exhibit on a different electronic device connected to the network 301. The information may be the exhibit itself. In some embodiments, the term to exhibit associations for the first user are stored in a data file maintained in memory accessible to the application platform 401. In some embodiments, the term to exhibit associations for the first user are stored in a database accessible to the application platform 401. In some embodiments, the first user may view the stored associations to each exhibit for each term. The associations may be presented to the user in the form of a user-specific dictionary of customized term to exhibit associations.

The method 100 further includes displaying, by the application platform, the at least one term and a representation of the exhibit (104). The display component 403 in some embodiments performs this by displaying the term as a hyperlink. Selection of the hyperlink may cause navigation to a folder of related exhibits. Selection of the hyperlink may cause navigation to a list of exhibits. Selection of the hyperlink may cause the display component 403 to display a drop-down menu listing the exhibits. The display component 403 in some embodiments displays the at least one term with a button. Selection of the button may cause navigation to a folder of related exhibits. Selection of the button may cause navigation to a list of names of exhibits. Selection of the button may cause the display component 403 to display a drop-down menu listing the exhibits. The display component 403 may display an icon representing each exhibit. The display component 403 may organize the exhibits into categories for display. The categories may be based on file type; for example, one category may be video files, and another category may be text files. The categories may be based on the source of the exhibits; for instance, all exhibits submitted by co-workers may belong to a category. The display component 403 may display an icon representing each category of exhibit.

Some embodiments, where the application platform receives a plurality of second instructions, also involve ranking, by the application platform, the plurality of exhibits identified by the plurality of second instructions, and displaying, by the application platform, representations of the plurality of exhibits in order of ranking. The display component 403 may rank the exhibits according to when they arrived. The display component 403 may rank the exhibits based on file type. In some embodiments, the display component 403 maintains categories of relationships between the first user and the additional users causing the exhibits to be associated with the at least one term. In some embodiments, the display component 403 ranks the exhibits according to the category of relationship. In some embodiments, the display component 403 maintains categories according to the dates of inception for relationships between the first user and the additional users causing the exhibits to be associated with the at least one term. In some embodiments, ranking the exhibits comprises receiving ranking instructions from the first user.

In some embodiments, the display of the at least one term and the representation of the exhibit is filtered by receiving, by the application platform, an instruction from the first user not to display the representation of at least one exhibit, and displaying, by the application platform, the representations only of exhibits not identified in the instruction not to display. In some embodiments, the instruction from the first user is to display each exhibit only once, and the display component 403 displays each exhibit associated with a term the first user has directed the display component 403 to display only once. In some embodiments, the first user instructs the display component 403 not to display a particular exhibit by selecting that exhibit using manual entry devices coupled to the application platform. In some embodiments, the first user instructs the display component 403 not to display the exhibits associated with a particular term by selecting that term using manual data entry devices coupled to the application platform. In some embodiments, the display component 403 allows the first user to see exhibits currently suppressed from displaying. In some embodiments, the first user can instruct the display component 403 to display exhibits currently suppressed from displaying. In some embodiments, the display component 403 always suppresses the exhibits associated with a term from displaying unless the first user instructs otherwise.

In some embodiments, displaying the at least one term and the representation of the exhibit further comprises printing a document containing the at least one term and a code containing a representation of the exhibit. The code may be anything that the scanner 405 can convert into a digital pattern. The code may be a bar code. The code may be a QR code. The code may be an RFID device. The code may be a magnetically readable device. The code may be text. The code may contain a network address at which a scanning electronic device may locate an exhibit. The code may contain a network address at which a scanning electronic device may locate a plurality of exhibits. The network address may be a location at which a scanning electronic device can retrieve all of the exhibits associated with terms in the document. The code may contain an exhibit. The code may contain all of the exhibits.

The method 100 additionally includes receiving, by the application platform, a selection, by a user, of the representation of the exhibit (105). The user may enter the selection via data entry means coupled to the application platform 401. The user may enter the selection via data entry means coupled to a client device the user is utilizing. The user may enter the selection via manual data entry means.

The method 100 includes displaying, by the application platform, the exhibit (106) as well. In some embodiments, the display component 403 displays the exhibit using a display (not shown) accessible to the application platform 401. In some embodiments, the display component 403 displays the exhibit by transmitting the exhibit over the network 301 to another electronic device (not shown). The exhibit may be transmitted by any means usable for transmitting binary data via a network. The exhibit may be sent using SMTP. The exhibit may be sent using FTP. The exhibit may be transmitted via TCP/IP. The exhibit may be transmitted via HTTP. The exhibit may be streamed to the electronic device. In some embodiments, the display component 403 displays the exhibit by transmitting a network address at which the exhibit is located to an electronic device.

In some embodiments, displaying the at least one term and the representation of the exhibit further comprises receiving, by the application platform, an instruction from the first user associating the at least one term with a second term, receiving, by the application platform, an instruction from the first user, directing the application platform to display the second term, displaying, by the application platform, the second term and a representation of each exhibit linked to the first term, receiving, by the application platform, a selection by a user of at least one of the representations, and displaying, by the application platform, the exhibit corresponding to the selected representation. The first user may enter the instruction via data entry devices coupled to the application platform 401. In some embodiments, the first user enters the instruction via manual data entry devices. The display component 403 in some embodiments displays menus that permit the first user to select the second term. The menus may list terms. The menus may list terms that the first user selected in step 101 of this method 100. In some embodiments, the user enters the instruction by highlighting the first term, selecting a button, and highlighting the second term. In some embodiments, the user enters the instruction via a dialog box.

In some embodiments, each association between terms the user has created is stored in memory accessible to the application platform 304. In some embodiments, associations between terms are stored in a data file accessible to the application platform 401. In some embodiments, the associations between terms are stored in a database accessible to the application platform 401. In some embodiments, the first user may view the stored associations between terms. The associations may be presented to the user in the form of a user-specific thesaurus of customized associations between terms.

Some embodiments involve maintaining, by the application platform, a thesaurus of lexicographic relationships between terms, retrieving, by the application platform, from the thesaurus a list of terms related to the at least one selected term, and displaying, by the application platform, the list to the first user. In some embodiments, the application 304 records the use of terms by the first user and compares the relationships between terms as used by the first user to their use in the thesaurus. In some embodiments, when the application 304 detects a novel term relationship, it adds that use to the thesaurus. In some embodiments, the application 304 maintains a threshold number for novel term relationships; a novel term relationship is added only after the number of distinct instances of the novel term relationship exceeds the threshold number. In some embodiments, the novel term relationship is added only after the number of distinct users applying that relationship exceeds the threshold number.

Some embodiments also involve maintaining, by the application platform, a set of user-specific display rules, identifying, by the application platform, a user, and displaying, by the application platform, only the content permitted to display to that user by the user-specific display rules. The user-specific rules may cause some exhibits not to display when a particular user selects their representation. The user-specific rules may cause some representations of exhibits not to display when a particular user views the term associated with those exhibits. The user-specific rules may cause some terms not to display when a particular user views a document containing those terms. The user-specific rules may cause a section of a document not to display when a particular user views the document. The user-specific rules may cause an entire document not to display when a particular user attempts to view it. In some embodiments, the display component 403 identifies the user who is subject to the user-specific rules by identifying a particular machine associated with the user. In some embodiments, the display component 403 identifies the user by identifying a particular network address associated with the user. In some embodiments, the display component 403 identifies the user by the user's logon information. For instance, the application 304 may require the user to create a user account to view the displayed content. The application 304 may require the user to navigate to the application via a social network that identifies the user. In some embodiments, the display component 403 enforces the user-specific rules by not displaying data the rules direct the display component 403 not to display via a display coupled to the application platform. In some embodiments, the display component 403 enforces the user-specific rules by not transmitting data the rule directs the display component 403 not to display to an electronic device via the network 301.

Embodiments of the above-described method and system provide a user with the ultimate tool in shaping and controlling her online persona. The user can marshal files from around the network to build a unique and vibrant personal narrative. The user can take advantages of social connections by inviting other people to augment the document through the inclusion of their own exhibits, and by disseminating a completed document through all existent channels of electronic communication.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for producing documents with embedded media, the method comprising:
receiving, by an application platform, a first instruction from a first user selecting at least one term;
receiving, by the application platform, at least one second instruction selecting an exhibit, and linking that exhibit to the at least one term;
receiving, by the application platform, a third instruction, from the first user, to display the at least one term;
displaying, by the application platform, the at least one term and a representation of the exhibit;
receiving, by the application platform, a selection, by a user, of the representation of the exhibit; and
displaying, by the application platform, the exhibit.

2. A method according to claim 1, wherein receiving the first instruction further comprises:
maintaining a dictionary of terms; and
receiving a selection of at least one term in the dictionary from the first user.

3. A method according to claim 2, further comprising:
displaying, by the application platform, a set of term category descriptions;
receiving, by the application platform, a selection by the first user of a category description; and
displaying, by the application platform, terms associated with that category description.

4. A method according to claim 1, wherein receiving the first instruction comprises receiving at least one term entered by the first user and receiving a selection of the at least one entered term.

5. A method according to claim 1, wherein receiving the at least one second instruction comprises receiving the at least one second instruction from the first user.

6. A method according to claim 1, wherein receiving the at least one second instruction comprises:
receiving an instruction from the first user identifying at least one additional user;
sending the at least one term to an electronic device used by the at least one additional user; and
receiving the at least one second instruction from the electronic device.

7. A method according to claim 6, wherein the at least one term is sent to the electronic device by means of a social network.

8. A method according to claim 6, further comprising receiving the exhibit from the electronic device.

9. A method according to claim 6, wherein sending the at least one term further comprises:
placing the at least one term in a document; and
sending the document to the electronic device.

10. A method according to claim 6, further comprising
receiving, by the application platform, an instruction from the first user identifying terms to which the at least one additional user may link exhibits; and
displaying the representation of the exhibit only if the second instruction directs the application platform to link the exhibit to one of the identified terms.

11. A method according to claim 1, wherein receiving the second instruction further comprises:
sending, by the application platform, a query to at least one electronic device;
receiving, by the application platform, a list of potential exhibits matching the query from the at least one electronic device;
displaying, by the application platform, the list of potential exhibits to a user; and
receiving, by the application platform, an instruction selecting at least one potential exhibit from the list.

12. A method according to claim 1, wherein receiving the third instruction comprises:
receiving, by the application platform, text entered by the first user; and
identifying, by the application platform, the at least one term in the text.

13. A method according to claim 1, wherein the application platform receives a plurality of second instructions, and further comprising:
ranking, by the application platform, the plurality of exhibits identified by the plurality of second instructions; and
displaying, by the application platform, representations of the plurality of exhibits in order of ranking.

14. A method according to claim 13, wherein ranking the exhibits comprises receiving ranking instructions from the first user.

15. A method according to claim 1, wherein displaying the at least one term and the representation of the exhibit further comprises:
receiving, by the application platform, an instruction from the first user not to display the representation of at least one exhibit; and
displaying, by the application platform, the representations only of exhibits not identified in the instruction not to display.

16. A method according to claim 1, wherein displaying the at least one term and the representation of the exhibit further comprises printing a document containing the at least one term and a code containing a representation of the exhibit.

17. A method according to claim 1, further comprising:
receiving, by the application platform, an instruction from the first user associating the at least one term with a second term;
receiving, by the application platform, an instruction from the first user, directing the application platform to display the second term;
displaying, by the application platform, the second term and a representation of each exhibit linked to the first term;
receiving, by the application platform, a selection by a user of at least one of the representations; and
displaying, by the application platform, the exhibit corresponding to the selected representation.

18. A method according to claim 17, further comprising:
maintaining, by the application platform, a thesaurus of lexicographic relationships between terms;
retrieving, by the application platform, from the thesaurus a list of terms related to the at least one selected term; and
displaying, by the application platform, the list to the first user.

19. A method according to claim 1, further comprising:
maintaining, by the application platform, a set of user-specific display rules;
identifying, by the application platform, a user; and
displaying, by the application platform, only the content permitted to display to that user by the user-specific display rules.

20. A system for producing documents with embedded media, the system comprising:
an application platform comprising at least one server connected via a network to at least one client device;
a data collection component, executing on the application platform, receiving a first instruction from a first user selecting at least one term, receiving at least one second instruction selecting an exhibit, and directing the application platform to link that exhibit to the at least one selected term, receiving a third instruction, from the first user, directing the application platform to display the at least one selected term, and receiving, by the application platform, a selection by a user of a representation of the exhibit; and
a display component, executing on the application platform, displaying the at least one selected term and a representation of the exhibit, and displaying the exhibit.
